(19) United States
(12) Patent Application Publication
(10) Pub. No.: US 2005/0049928 A1
(43) Pub. Date: Mar. 3, 2005

(54) Universal sales receipt device and system

(75) Inventors: Indran Naick, Cedar Park, TX (US); Jeffrey Kenneth Wilson, Austin, TX (US)

Correspondence Address: IBM CORPORATION (DWL);C/O LALLY & LALLY, L.L.P., P. O. BOX 684749, AUSTIN, TX, 78768-4749, US

(73) Assignee: International Business Machines Corporation, Armonk, NY (US)

(21) Appl. No.: 10/650,908

(22) Filed: Aug. 28, 2003

(51) Int. Cl. G06F 17/60

(52) U.S. Cl. 705/26

(57) ABSTRACT

An apparatus extracts a predetermined set of information from each of a plurality of sales receipts, including a first and second sales receipt corresponding to first and second transactions with first and second vendors respectively. The apparatus provides the extracted information to a data processing system. The first transaction may represent a sale of goods while the second transaction represents a sale of services wherein the predetermined set of information for goods and services transactions is the same. The predetermined set of information may include vendor identification information and at least one instance of product identification information. The apparatus may access a database using the vendor identification and product identification information to retrieve a description of the corresponding product. The predetermined set of information may include a receipt serial number wherein the device uses the serial number to retrieve information about the corresponding transaction from a sales receipt database.

### BACKGROUND

1. Field of the Present Invention

The present invention is related to data acquisition systems and more particularly to systems for acquiring data regarding the purchases of a consumer or business.

2. History of Related Art

For most entities (persons and businesses), managing purchases requires some level of manual transcription and/or data entry. Moreover, to the extent that automated systems do exist, such systems are generally not applicable or suitable for all kinds of purchases made by the entity. As an example, there are now refrigerators capable of receiving information regarding products placed in the refrigerator using product stickers that transmit low frequency radio signals. These refrigerators are capable of identifying all items that are placed in the refrigerator to facilitate a variety of tasks including, for example, the generation of shopping lists based on the current contents of the refrigerator. The limitations of such as a system with respect to purchases generally will be obvious. The refrigerator device is designed to record information about only those things that are placed in the refrigerator. Other items such as canned goods and/or cleaning supplies not generally stored in the refrigerator are not addressed by the refrigerator-type system. In addition, some products, such as gasoline, are not generally provided in a package that is brought into the home or business. Moreover, many purchases involve services rather than goods. Doctor visits, insurance payments, movie tickets, dinner out, and so forth are all examples of purchases outside the scope of existing purchasing data acquisition systems.

The variety of goods and services on which people and businesses spend money is seemingly infinite. It would be highly desirable, nevertheless, to implement the required devices and methods for a system of acquiring, storing, and ultimately analyzing purchase information without special regard to item/service being purchased.

### SUMMARY OF THE INVENTION

The goal identified above is addressed according to the present invention by a universal method and system for acquiring purchasing information from sales receipts. The invention recognizes that sales receipts represent the only document that is almost universally provided in conjunction with the sale of goods and services. In one embodiment, the system includes a universal receipt device configured to extract purchasing information from a sales receipt. The information may include information identifying the seller, the date and time, and the products/services purchased. In addition, the receipt may include additional information such as the number or quantity of each device as well as the price. The receipt device may read or scan alphanumeric information using optical character recognition techniques while the device may also read encoded information such as a bar code or other digitally stored information on the receipt. The receipt may include a form of alterable memory for storing data about the purchases.

The universal receipt device system can operate on a minimum set of information in conjunction with external databases. In one embodiment, for example, the receipt device may merely collect information about the store and the store's product code for each item purchased from the store. The information would be extracted from the receipt and offloaded to a system such as a data processing system for further processing. In one embodiment, the system is configured to read the receipt number information and the vendor identified. The system could then submit the list of product ID's to the seller or a third party provider to determine the description of the goods and services. Once this information is stored in the database, conventional data base algorithms and procedures could be applied to analyze the spending habits of the consumer.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing system according to one embodiment of the invention;

FIG. 2 illustrates a receipt suitable for use with the system of FIG. 1;

FIG. 3 depicts selected elements of the universal receipt device of FIG. 1;

FIG. 4 is a flow diagram illustrating a method of managing purchasing information with sales receipt information according one embodiment of the present invention; and

FIG. 5 is a flow diagram of a method of providing sales receipt processing services according to one embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates a system and method for acquiring information about purchases that is universally applicable across all types of products and services. The system includes a universal receipt device that is designed to extract certain key information from a standard sales receipt. In one embodiment, the sales receipt may be formatted according to a sales receipt format or standard while, in other embodiments, the receipt does not necessarily conform to any of particular standard or format. A sales receipt is provided and the receipt device “reads” the receipt to extract at least a minimum of information. At one end of the spectrum, the receipt device may scan for little more than an identifier of the receipt itself. In this embodiment, each receipt might include its own unique receipt number such as a serial number. In another embodiment requiring less infrastructure, each vendor or seller would assign unique serial numbers to each receipt generated by the vendor thereby enabling the customer to identify a receipt by its vendor number and serial number. Using just this minimum of information, the universal receipt can provide a data processing system with sufficient information to enable the system to extract more detailed information from the sales receipt database provided by or corresponding to the vendor.

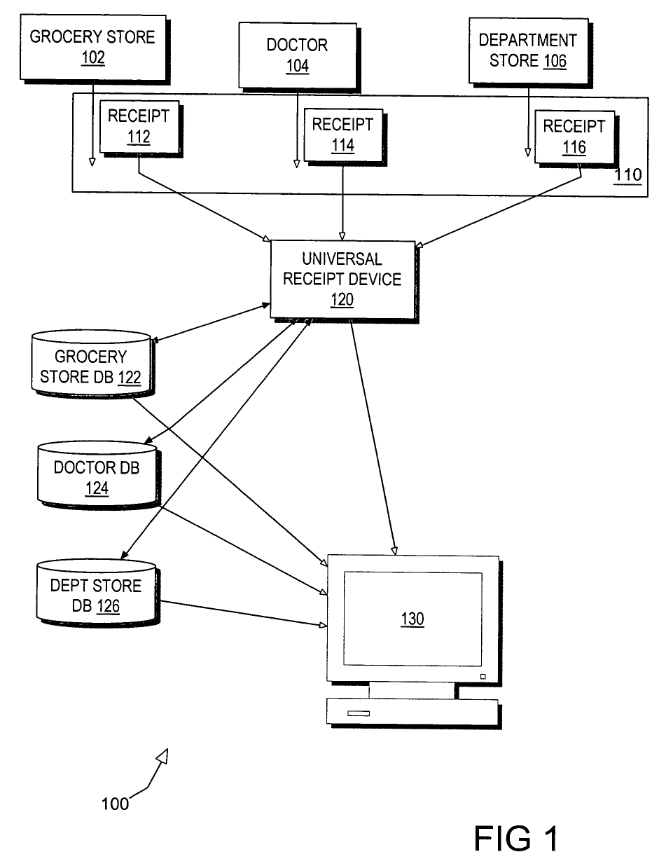

Turning now to the drawings, FIG. 1 is a depiction of selected elements of a system 100 for acquiring and using purchase information according to one embodiment of the invention. The depicted embodiment of system 100 includes a universal receipt device 120 that extracts purchase information from a set 110 of sales receipts. In the illustration, the set 110 of sales receipts includes a first receipt 112 generated by a first vendor (grocery store) 102, a second receipt 114 generated by a second vendor (doctor) 104, and a third receipt 116 generated by a third vendor (department store) 106.

The number of types of receipts that may be included within set 110 is theoretically unbounded. The receipts and vendors selected for illustration in FIG. 1 emphasize important characteristics of the universal receipt device and system. Specifically, the set 110 of sales receipts reflect a diverse set of purchases. The grocery store 102 represent a class of vendors that generally provide consumable, low cost items while doctor 104 represents a class of vendors that primarily sell services. Service transactions are fundamentally different than goods transactions because the buyer of services does not generally receive a tangible product as part of the transaction. An implication of this distinction for purposes of a universal system for collecting purchase information is that the universal system cannot depend upon any method or device in which purchasing information is somehow derived from the purchased product if it is to include service transactions. Similarly, the set 110 of receipts could include a receipt for a product that is not “scannable” in a traditional sense such as gasoline. The set 110 of receipts also includes a department store receipt 116 intended to emphasize the variety of goods transactions contemplated by the present invention. Limitless other receipts could be incorporated within set 110.

Universal receipt device 120 is configured to extract purchase information from each of the receipts 112, 114, 116. More specifically, universal receipt device 120 extracts a common or universal set of purchase information from each receipt. The universal set of purchase information represents sales information that is applicable to substantially all types of transactions. The universal set of information could include, as examples, information identifying the vendor, the transaction date, and the product(s) purchased. System 100 and universal receipt device 120 recognize the sales receipt as perhaps the only common element of the variety of transactions represented by set 110 of receipts. Because sales receipts are applicable to almost any commercial transaction imaginable and because sales receipts are routinely generated or capable of being generated for any transaction, the use of the sales receipt as the cornerstone of a purchasing information acquisition system results in reduced impact on the vendors. In other words, by employing a document that is already being produced, the present invention does not require vendors to alter their business practices substantially. Although one embodiment of the invention contemplates a standardized format or appearance of the sales in set 110, a standardized format is not a strict requirement so that businesses are not required to alter the presentation of the their receipts in any way.

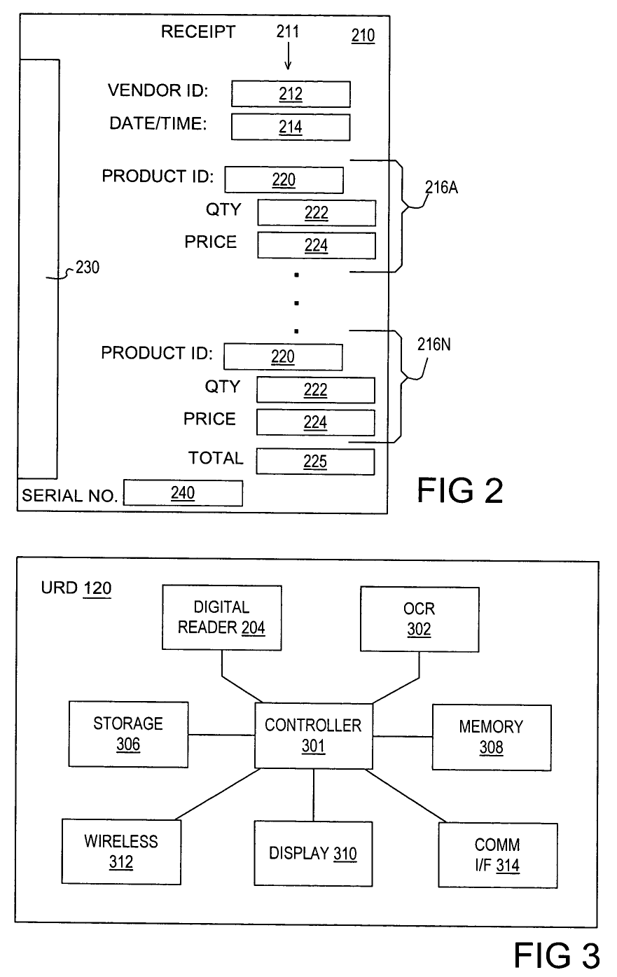

Universal receipt device 120 is preferably capable of extracting information from an alphanumeric portion of a sales receipt as well as from a digitized information encoded on or within the receipt. Referring to FIG. 2, an exemplary sales receipt 210 suitable for use with the present invention is depicted. Sales receipt 210 is a universal receipt that can be used as the basis for any of the receipts in the set 110 of receipts depicted in FIG. 1.

Sales receipt 210 as depicted in FIG. 2 includes alpha information 211 and digital information 230, both of which are indicative of the product(s) purchased. The alpha information 211, as its name implies, contains textual information that records and conveys the essential elements of the corresponding transaction. The alpha information includes vendor identification information 212 and time stamp information 214 indicating the date and time of the transaction. Alpha information 211 further includes a series of product information instances 216A through 216N (generically or collectively referred to as product information 216) and total cost information 225. Each instance of product information 216 includes text-conveying information about the product purchased. The depicted embodiment of product information 216 includes product identification information 220, quantity information 222, and price information 224 indicating a unit price of the corresponding product.

Product identification information 220, according to one embodiment includes a textual description (usually brief) of the corresponding product. Product identification information 220 may also include or be implemented as a numeric or alphanumeric representation of the product. Vendor part numbers, for example, may be included in product identification information 220.

The depicted embodiment of sales receipt 210 includes a serial number 240 that is a unique identifier of sales receipt 210. The serial number 240 may be unique within the context of all receipts issued by the corresponding vendor. In another embodiment, the serial number 240 is a unique serial number with respect to all receipts in the set 110 of sales receipts. This embodiment would likely be implemented with the assistance of a third party provider. At the time of a transaction, the third is contacted, likely through an automated electronic accessing system, and issues a unique serial number. While this embodiment implies additional processing, it beneficially enables a system in which the serial number 240 is the only information required to be in a format that is readable by universal receipt device 120. Once the absolutely unique serial number is known, the serial number can be used to access other information about the corresponding on the sales receipt about the transaction. More generally, the present invention can be implemented along a spectrum in which the amount of information extracted from receipt 210 by universal receipt device 120 increases as the amount of information that must be stored in an accessible database decreases. At one end of the spectrum, the information extracted might consist of nothing more than an absolutely unique serial number 240. In this embodiment, all other information regarding the corresponding transaction, including the serial number itself, is then stored in a database. While this embodiment minimizes front-end complexity by minimizing demands on universal receipt device 120 and constraints on receipt 210, it implies an enormous database of transaction information. At another end of this spectrum, universal receipt device 120 may extract all of the information that is represented in receipt 210. This embodiment minimizes or eliminates the need for an external database of transaction information at the cost of increased sophistication and coordination between universal receipt device 120 and receipts 210.

Returning to FIG. 1, the depicted embodiment of system 100 includes a plurality of databases 122, 124, and 126. Each database 122, 124, and 126 belongs to one of the vendors 102, 104, and 106. In one embodiment, each database includes a catalogue of vendor product numbers and a corresponding detailed description of the product. In one embodiment, databases 122, 124, and 126 include copies or summaries of sales receipt generated by the corresponding vendor such that, when a vendor generates a receipt, it stores the receipt or a representation of the receipt in the database. Databases 122, 124, and 126 are accessible from either universal receipt device 120, data processing system 130, or both. Databases 122, 124, and 126 may reside at different physical locations or be co-located and/or maintained by a third party database provider.

The present system contemplates a universal receipt device 120 for extracting a universal set of information from a set of receipts. The described embodiments reflect a spectrum of extraction/storage options possible. More specifically, universal receipt device 120 may extract vendor identification information 212, timestamp info 220, and product identification information(s) 216 from receipt 210 while employing one or more databases 122 through 126 to store, for example, a complete description associated with each product identification information. In this embodiment, universal receipt device might extract the vendor part numbers from product identification information 220 and use a database corresponding to vendor identification information 212 to retrieve a description of the product. Each vendor would maintain or provide for a database in which vendor parts numbers may be used to access and retrieve descriptive information about the corresponding product.

Referring to FIG. 3, selected elements of an exemplary embodiment of universal receipt device 120 are illustrated. In the depicted embodiment, universal receipt device 120 is driven by a controller 301 connected to various peripheral elements. The depicted peripherals include a digital reader 304 for reading digital information 230 and an optical character recognition (OCR) device 302 for scanning or reading alphanumeric information 211 of receipt 210. The digitized information 230 may be implemented as a bar code and digital reader 304 as a bar code reader. In another embodiment, receipt 210 implements a form of digital storage or memory that can be read by digital reader 204. In this case, the receipt 210 may incorporate magnetic or optical storage elements analogous to similar storage elements found in diskettes or CD ROMs.

In conjunction with optical character reader 302, universal receipt device 120 may be configured to scan for and recognize certain predetermined keywords and/or symbols to identify information fields contained in receipt 210. Using this technique, minor modifications to a vendor's existing receipt form would enable universal receipt device 120 to extract purchase information from the receipt without requiring significant knowledge about the receipt's format using conventional character recognition techniques. A predetermined symbol or keyword placed adjacent to the vendor's identification, for example, would enable universal receipt device 120 to find the vendor information within the receipt.

Universal receipt device 120 is shown as further including a non-volatile storage element 306 that may contain the device's microcode. Storage 306 may also be used as a database cache in which storage element 306 stores information recently retrieved from an external database such as the description accompanying the most recently used vendor part number. A memory element 308 provides working memory for controller 301. The depicted embodiment of universal receipt device 120 is further shown as including a wireless transmit/receive element 312, a display 310 and a communication interface 314. The wireless element 312 enables universal receipt device 120 to access external databases 122, 124, and 126 and may provide the means by which universal receipt device 120 communicates with data processing system 130. Communication interface 314 supports a standard communication port such as a conventional serial port to enable a wired mechanism for communicating information from universal receipt device 120 to data processing system 130. Display device 310 enables universal receipt device 120 to communicate with its user. Universal receipt device 120 may support a graphical user interface (GUI) that can guides a user through the process of extracting information from a receipt “manually.” In cases where universal receipt device 120 does not recognize the format of the receipt or cannot determine certain information contained on the receipt, universal receipt device 120 is preferably configured to prompt the user to enter information or assist the universal receipt device to find the information.

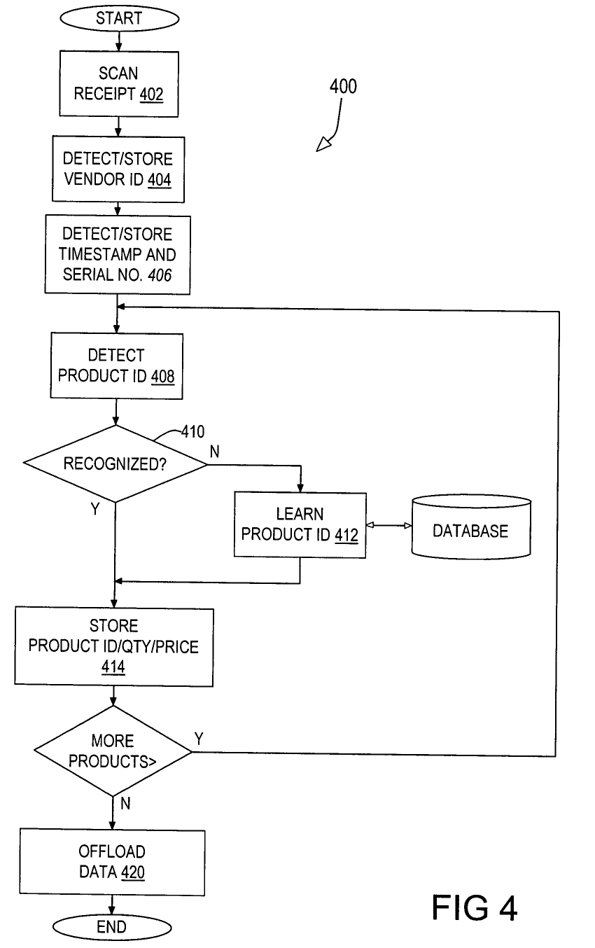

Portions of the present invention may be implemented as a computer program product, i.e., a set of computer executable instructions stored on a computer readable medium for performing various methods. Referring to FIG. 4, a flow diagram of a method 400 of acquiring purchasing information from one or more sales receipts is depicted according to one embodiment of the present invention. In the depicted embodiment, universal receipt device 120 is used to read or scan (block 402) a receipt. The receipt may include digitized information as well as alphanumeric information. After determining what type or format of information is contained on the receipt, universal receipt device 120 attempts to detect and store (block 404) vendor identification information and timestamp information (block 406) and receipt serial number information if present. As indicated previously, extracting information from receipt 210 may include reading alphanumeric information, digital information, or both. The information may be identified with predetermined demarcation keywords and/or symbols to facilitate the extraction process. In this embodiment, a particular piece of information to be extracted from a receipt may be located anywhere on the receipt and universal receipt device 120 locates the device by locating the corresponding demarcation keyword or symbol.

The universal receipt device 120 then attempts to detect and extract (block 408) product information including product identification information for each product contained on the receipt. For each product detected, universal receipt device 120 determines whether the product is recognized (block 410). Universal receipt device 120 may store recently accessed product identification information in storage area 306 and/or memory 308. If a particular piece of product identification information is not recognized, universal receipt device 120 may “learn” (block 412) the product associated with the unrecognized identifier by accessing an external database. Accessing the databases may be achieved directly or through the intermediate data processing system 130. After universal receipt device 120 has sufficient information to identify a product, the product information including identification information, quantity information, and price information for each product purchased is stored (block 414) locally. When all products have been accounted for, universal receipt device 120 then offloads (block 420) the data to data processing system 130 for various purposes including importation into financial software that can be used to analyze and otherwise manipulate the purchasing information.

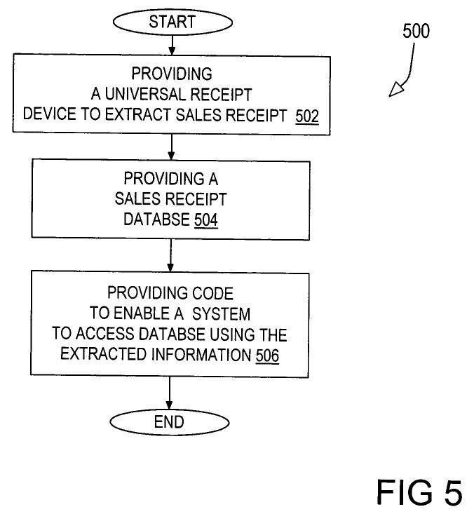

One embodiment of the present invention contemplates the provision of sales receipt acquisition services to others. Referring now to FIG. 5, a flow diagram of a method 500 of providing sales receipt information acquisition according to the present invention is depicted. In the depicted embodiment, method 500 includes providing (block 502) a universal receipt device, such as universal receipt device 120, that is configured to extract sales receipt information from a set of sales receipts reflecting a diverse set of transactions, vendors, and sales receipt formats. One or more sales receipt databases are provided (block 504). The sales receipt databases may include vendor part number catalogues for each vendor and/or copies of actual sales receipts. A customer's data processing system is then configured (block 506), by the installation of software for example, to enable the system to access the database using the information extracted from the sales receipt (e.g., a numeric product identifier) to retrieve additional information (e.g., a product description) about the transaction.

It will be apparent to those skilled in the art having the benefit of this disclosure that the present invention contemplates a mechanism for securing a pair of mated cable connectors. It is understood that the form of the invention shown and described in the detailed description and the drawings are to be taken merely as presently preferred examples. It is intended that the following claims be interpreted broadly to embrace all the variations of the preferred embodiments disclosed.

1. A system for accumulating purchasing information for a purchased product or service, comprising:
a device to acquire a universal set of purchasing information from each of a set of sales receipts, wherein the set of sales receipts includes a first receipt pertaining to a first transaction with a first vendor and a second receipt pertaining to a second transaction with a second vendor;
a first database containing product identification information and corresponding descriptive information of the first vendor and a second database containing product identification and corresponding descriptive information of the second vendor;
means for accessing the first and second databases using the acquired product identification information to obtain descriptive information corresponding to the first and second transactions.

2. The system of claim 1, wherein the first transaction comprises a sale of services and the second transaction comprises a sale of goods wherein the universal set of acquired information for service transactions is the same as the acquired information for goods transactions.

3. The system of claim 2, wherein the acquired information further includes a sales receipt serial number and wherein using the acquired information to access the database includes using the serial number to access a database of sales receipts.

4. The system of claim 2, wherein the predetermined set of information includes a vendor identifier and a time stamp.

5. The system of claim 1, further comprising means for providing the acquired information to a data processing system.

6. The system of claim 5, wherein the means for providing the acquired information to the data processing comprises wireless means.

7. An apparatus configured to extract a predetermined set of information from a each of a plurality of sales receipts, the plurality of sales receipts including a first sales receipt corresponding to first transaction with a first vendor and a second sales receipt corresponding to a second transaction with a second vendor, wherein the apparatus is still further configured to provide the extracted information to a data processing system.

8. The apparatus of claim 7, wherein the predetermined set of information comprises a sales receipt serial number and wherein the device is further configured to use the serial number to retrieve information about the corresponding transaction from a sales receipt database.

9. The apparatus of claim 7, wherein the first transaction comprises a sales of goods and the second transaction comprises a sale of services and wherein the predetermined set of information for sales transactions is the same as the predetermined set of information for services transactions.

10. The apparatus of claim 11, wherein the predetermined set of information includes vendor identification information and at least one instance of product identification information.

11. The apparatus of claim 10, wherein the apparatus is further configured to access a database using the vendor identification information and the at least one instance of the product identification information to retrieve a description of the product identified by the corresponding instance of product identification information.

12. The apparatus of claim 7, wherein the apparatus includes an optical character recognition unit configured to extract the information from alphanumeric characters on at least on of the sales receipts.

13. The apparatus of claim 7, wherein the apparatus includes means for extracting the information from a digitized representation of the information on the sales receipt.

14. The apparatus of claim 7, wherein the apparatus is configured to locate at least one component of the predetermined set of information by locating a marker corresponding to the component on the sales receipt.

15. A method of enabling acquisition and management of purchasing information, comprising:
providing a device configured to extract a predetermined set of information from each of a plurality of sales receipts and further configured to forward the extracted information to a data processing system;
providing a sales receipt database;
providing computer code means suitable for execution on the data processing system, wherein the code means are configured to access the sales receipt database using at least a portion of the extracted information to retrieve additional information about the corresponding transaction.

16. The method of claim 15, wherein the extracted information includes a vendor identifier and wherein the sales receipt database comprises a sales receipt database corresponding to the identified vendor.

17. The method of claim 15, wherein the extracted information includes at least one instance of a numeric product identifier and further wherein accessing the sales receipt database comprises using the extracted instance of sales receipt identifier to access a description of the product corresponding to the product identifier.

18. The method of claim 15, wherein the extracted information includes a sales receipt serial number and wherein accessing the database comprises using the sales receipt serial number to retrieve information indicative of the products included in the transaction and the time and date of the transaction.

19. The method of claim 15, wherein the plurality of sales receipts includes a first receipt corresponding to a first transaction with a first vendor and a second transaction corresponding with a second vendor, wherein the first and second vendors are different and wherein formats of the first and second sales receipts are different.

20. The method of claim 19, wherein the first sales receipt corresponds to a sale of services and wherein the second sales receipt corresponds to a sale of goods, wherein the predetermined set of information for goods transactions is the same as the predetermined set of information for services transactions.
